(19) United States
(12) Patent Application Publication
(10) Pub. No.: US 2011/0032431 A1
(43) Pub. Date: Feb. 10, 2011

(54) FRAME INTERPOLATING DEVICE AND FRAME INTERPOLATING METHOD

(75) Inventors: Peishan Tsai, Tokyo (JP); Keiko Hirayama, Tokyo (JP)

Correspondence Address: PATTERSON & SHERIDAN, L.L.P., 3040 POST OAK BOULEVARD, SUITE 1500, HOUSTON, TX, 77056, US

(73) Assignee: Kabushiki Kaisha Toshiba, Tokyo (JP)

(21) Appl. No.: 12/830,766

(22) Filed: Jul. 6, 2010

(30) Foreign Application Priority Data
Aug. 6, 2009 (JP) 2009-183874

(51) Int. Cl. H04N 5/14

(52) U.S. Cl. 348/699; 348/E05.062

(57) ABSTRACT

A frame interpolating device includes: a motion vector matching module configured to perform block matching processing to output a plurality of block matching result for respective blocks in an interpolation frame generated by frame interpolating processing using a past frame and a current frame of an input video signal; a detection vector determining module configured to detect a combination of most similar image blocks in the past frame and the current frame from the block matching results and to employ the motion vector as a detection vector; a referenceability determining module configured to determine referenceability of the detection vector of a reference area; a final vector determining module configured to employ the detection vector as a motion vector of the screen edge area; and a frame interpolating module configured to perform frame interpolation processing using the employed detection vector of the reference area.

### CROSS-REFERENCE TO THE RELATED APPLICATION(S)

The present application is based upon and claims priority from prior Japanese Patent Application No. 2009-183874, filed on Aug. 6, 2009, the entire contents of which are incorporated herein by reference.

### BACKGROUND

1. Field

The present invention relates to a frame interpolating device and a frame interpolating method.

2. Description of the Related Art

A digital image processing device provided in apparatus such as TV receivers having a liquid crystal display are generally configured to perform generating an interpolated image by interpolating frames in a video image. If motion vectors become large in an area close to the top, bottom, left, or right end of a screen, the vectors become more likely to be detected as errors and an interpolated image may become likely to be deteriorated.

In view of the above, in a conventional frame interpolating method disclosed in JP-A-2008-118505, a vertical component and a horizontal component of a motion vector are switched independently so that only the vertical component of the motion vector is made zero in areas close to the top and bottom ends of the screen and only the horizontal component of the motion vector is made zero in areas close to the left and right ends of the screen. However, a detected motion vector may be deviated from a correct vector when horizontal or vertical high-speed text scrolling or the like is performed.

### BRIEF DESCRIPTION OF THE DRAWINGS

A general configuration that implements the various features of the present invention will be described with reference to the drawings. The drawings and the associated descriptions are provided to illustrate embodiments of the invention and not to limit the scope of the invention.

FIG. 1 is a block diagram showing the configuration of a broadcast recording apparatus relating to an embodiment of the present invention.

FIG. 2 is a block diagram showing the configuration of an interpolation frame generating device according to the embodiment.

FIG. 3 illustrates an example block matching operation.

FIG. 4 shows specific examples of the size of a macroblock and a search range for it.

FIG. 5 is a graph showing a relationship (SAD characteristic) between the shift amount of an image block and the SAD in block matching.

FIG. 6 is a block diagram showing an example configuration of a motion vector detector of the embodiment.

FIG. 7 schematically shows left and right screen edge areas and reference areas on the screen which are used in the embodiment.

FIG. 8 is a flowchart of a process which is executed by the motion vector detector of the embodiment.

FIG. 9 is a block diagram showing an example configuration of a conventional motion vector detector.

FIG. 10 is a flowchart of a process which is executed by the conventional motion vector detector of FIG. 9.

### DETAILED DESCRIPTION

An embodiment according to the present invention will be described in detail with reference to the accompanying drawings. The scope of the claimed invention should not be limited to the examples illustrated in the drawings and those described below.

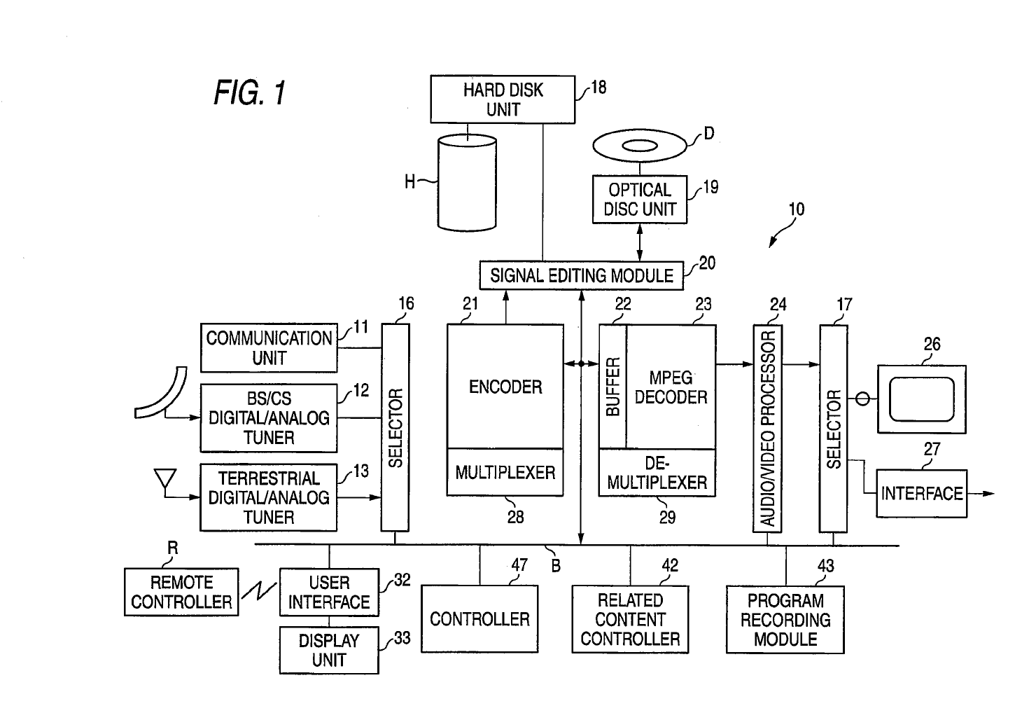

FIG. 1 is a block diagram showing a configuration of a broadcast recording apparatus relating to the embodiment of the invention. The broadcast recording apparatus 10 shown in FIG. 1 as an example is a digital TV receiver having a recording function which uses tuners as video sources. However, the present invention may be applied suitably to a hard disk recorder having such video sources and a recording function.

Therefore, although in the following description of the embodiment which will be made with reference to FIG. 1 the digital TV receiver having a recording function will be described in detail, the following description can also be construed as one for a hard disk recorder having the same functions as the digital TV receiver when a display 26 is removed from FIG. 1.

As shown in FIG. 1, the broadcast recording apparatus (digital TV receiver) 10 is equipped with two types of disc drives, which are a hard disk unit 18 which accesses a hard disk H as a first medium and an optical disc unit 19 which rotationally drives an optical disc D which is an information recording medium (second medium) on which video files can be stored and which writes and reads information to and from it. To control the operation of the broadcast recording apparatus 10 as a whole, a controller 47 is connected to other components via a data bus B. However, the optical disc unit 19 may not be provided in the broadcast recording apparatus 10.

The broadcast recording apparatus 10 shown in FIG. 1 is provided with: an encoder 21 which belongs to a recording section, an MPEG decoder 23 which belongs to a reproduction section, and the controller 47 which controls operations of other components. The broadcast recording apparatus 10 has an input selector 16 and an output selector 17. A communication unit 11 of LAN or the like, a satellite broadcast (BS/CS) digital/analog tuner 12, and a terrestrial digital/analog tuner 13 are connected to the input selector 16 and output a signal to the encoder 21. A satellite antenna is connected to the BS/CS digital/analog tuner 12 and a terrestrial antenna is connected to the terrestrial digital/analog tuner 13. The broadcast recording apparatus 10 is also equipped with a signal editing module 20 which receives an output of the encoder 21 and performs desired data processing such as data editing. The hard disk unit 18 and the optical disc unit 19 are connected to the signal editing module 20. The MPEG decoder 23 decodes a signal supplied from the hard disk unit 18 or the optical disc unit 19. The broadcast recording apparatus 10 is further equipped with a buffer 22, an audio/video processor 24, a multiplexer 28, a demultiplexer 29, a related content controller 42, and a program recording module 43. These components are connected to the controller 47 via the data bus B. An output of the output selector 17 is supplied to a display 26 or to an external apparatus via an interface 27 which performs a communication with the external apparatus. The display 26 is usually equipped with speakers for output audio.

Furthermore, the broadcast recording apparatus 10 is equipped with a user interface 32 which is connected to the controller 47 via the data bus B and receives a user operation and a operation made through a remote controller R. The remote controller R enables approximately the same operations as the user interface 32 does which is provided in the main body of the broadcast recording apparatus 10. That is, the remote controller R enables input of a recording/reproduction instruction for the hard disk unit 18 or the optical disc unit 19, input of an edit instruction, a tuner operation, and various kinds of setting such as setting of reservation recording.

The controller 47 supervises all operations, including the above-described receiving operation, of the broadcast recording apparatus 10. Incorporating a CPU etc., the controller 47 receives operation information from the user interface 32 and controls the individual sections so that the content of the operation is reflected in their operations.

The controller 47 incorporates a memory unit (not shown), which is provided with a ROM which is stored with control programs to be run by the CPU, a RAM which provides a work area for the CPU, and a nonvolatile memory to be stored with various kinds of setting information, control information, etc. The controller 47 is configured so that a content processed by the audio/video processor 24 is displayed and reproduced as video and audio, respectively, via the selector 17.

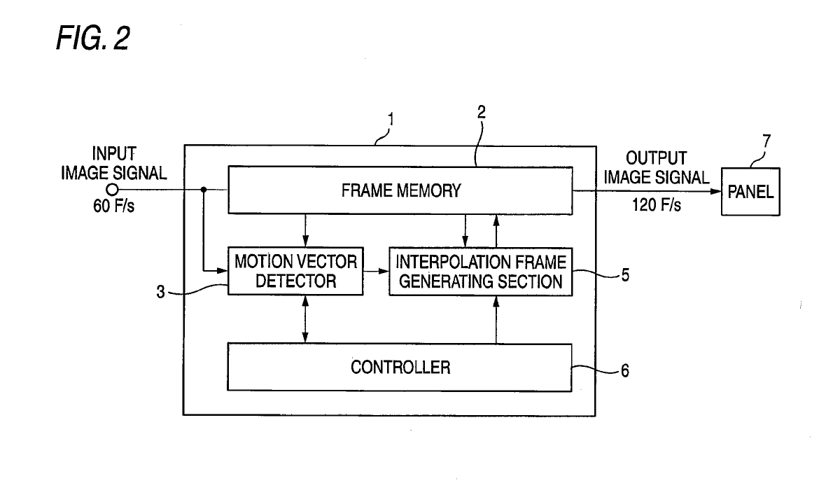

FIG. 2 is a block diagram showing the configuration of an interpolation frame generating device 1 as a frame interpolating device according to the embodiment of the invention. The interpolation frame generating device 1 corresponds to an interpolation frame generating function of the audio/video processor 24 shown in FIG. 1. An input signal of 60 frames/sec is supplied to a frame memory 2 and a motion vector detector 3. The motion vector detector 3 detects motion vectors from a past frame and current frame and outputs the detected motion vectors to an interpolation frame generating section 5. The interpolation frame generating section 5 generates an interpolation frame to be inserted between the past frame and the current frame based on motion vectors supplied from the motion vector detector 3.

An output image signal in which each interpolation frame generated by the interpolation frame generating section 5 is inserted between two interpolation subject frames is supplied to a panel 7 which is a display device corresponding to the display 26. A controller 6 is configured so as to control operations of the individual sections of the interpolation frame generating device 1.

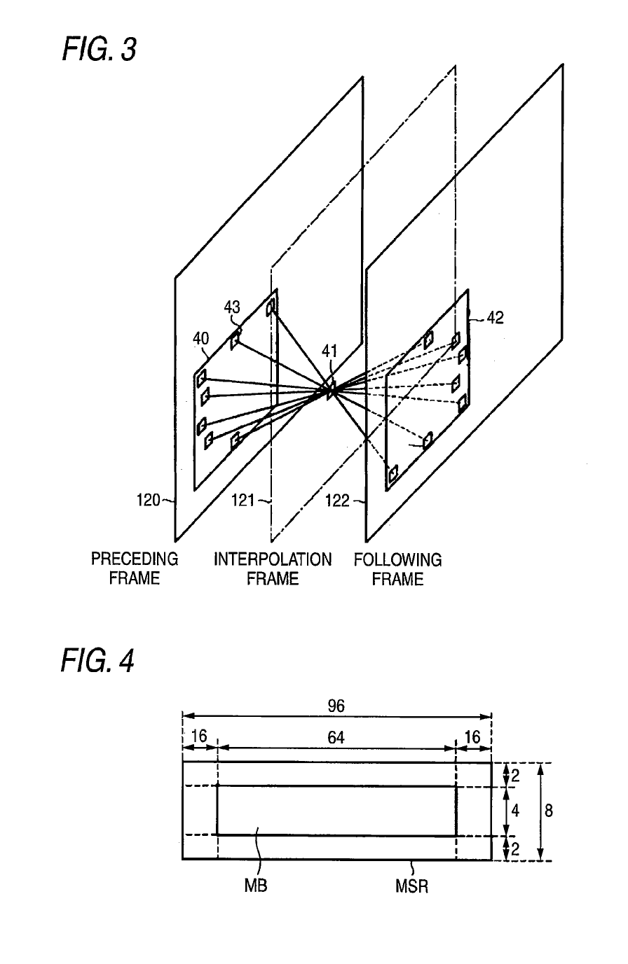

FIG. 3 illustrates an example block matching operation for detection of motion vector candidates. For example, the following method for detecting motion vector candidates by block matching is known. In this method, blocks having a prescribed shape are arranged (translated) in two respective frames 120 and 122 preceding and following an interpolation frame 121 so as to be point-symmetrical with respect to an insertion position (interpolation image block 41) of the interpolation frame 121. The absolute values of differences between pixel values of all corresponding pairs of pixels belonging to each pair of symmetrical blocks are calculated and added up (i.e., a SAD (sum of absolute difference) value is calculated). Directions whose SAD values are within a certain range are employed as motion vector candidates for the interpolation image block 41.

In the method of FIG. 3, a motion vector is determined using block matching between pairs of image blocks that are point-symmetrical with each other. A SAD value is calculated by comparing pixel values of each pair of image blocks in the preceding frame 120 and the following frame 122 that are symmetrical with respect to the insertion position in the interpolation image block 41 of the interpolation frame 121. Vectors connecting similar image blocks (i.e., pairs of image blocks whose SAD values are within a certain range) are employed as motion vector candidates of the interpolation image block 41. This comparison is performed in a prescribed search range 40 in the preceding frame 120 and a corresponding search range 42 in the following frame 122.

Although each motion vector candidate (having a magnitude and a direction) is shown in FIG. 3 like a three-dimensional vector for convenience of description, in actual processing it is a two-dimensional vector in the frame.

Next, a description will be made of the image block size and the motion vector search range.

FIG. 4 shows specific examples of the size of a macroblock and a search range for the macroblock. These macroblock and search range can be used for the block matching operation shown in FIG. 3. To simplify the description, a block matching operation in the horizontal direction will mainly be described below.

In FIG. 4, MB denotes a macroblock and MSR denotes a search range for the macroblock MB. For example, the size of the macroblock MB is 64×4 pixels as indicated by an inner solid line in FIG. 4. In a preceding frame 120, the macroblock MB is shifted by −16 to +16 pixels in the horizontal direction and by −2 to +2 pixels in the vertical direction. At the same time, in a following frame 122, the macroblock MB is shifted by −16 to +16 pixels in the horizontal direction and by −2 to +2 pixels in the vertical direction.

That is, when the macroblock MB is shifted by +12 pixels, for example, in the preceding frame 120 with an interpolation image block 41 (having the same size as the macroblock MB) to be inserted in an interpolation frame 121 as the center of point symmetry, the macroblock MB is shifted by −12 pixels in the following frame 122. A SAD value is calculated by comparing pixel values of corresponding pairs of pixels of corresponding image blocks in the frames 20 and 22. Therefore, in this example block matching operation using the macroblock MB, the search range MSR in each of the preceding frame 120 and the following frame 122 measures 96×8 pixels.

The most appropriate block size to be used for detecting a motion vector accurately by block matching depends on the resolution of an input frame and the manner of movement of an object included in the frame.

A detailed description will be made below of a block matching operation performed by the motion vector detector 3.

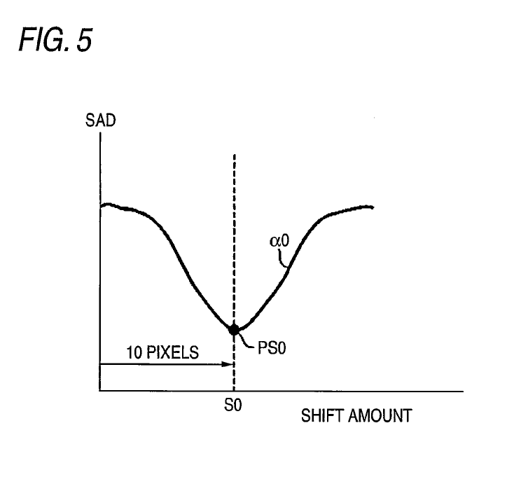

FIG. 5 is a graph showing a relationship (SAD characteristic) between the shift amount of an image block and the SAD in block matching. This block matching operation is performed by the motion vector detector 3. To simplify the description, only a block matching operation for a horizontal object movement will be described.

In this example, an image block 43 of attention in a preceding frame 120 including an object is shifted one pixel at a time starting from the position corresponding to a pixel block 44 located at the center in the search range in a following frame 122. The SAD takes a local minimum (in this example, a minimum) when the image block 43 has been shifted by 10 pixels (see FIG. 5). One motion vector candidate is detected based on the shift amount S0 of the local minimum point PS0 and its direction. Therefore, in this example, the motion vector of a pixel block 41 of attention is detected as 10 pixels in the horizontal direction. As a result, for example, a pixel block obtained by shifting an image block having the same pixel values as the image block 43 of attention by 5 pixels in the horizontal direction from the corresponding, same position in an interpolation frame 121 is generated as an image block in the interpolation frame 121. The shift amount S0 and the shift direction indicate a position of the image block 41 in its search range.

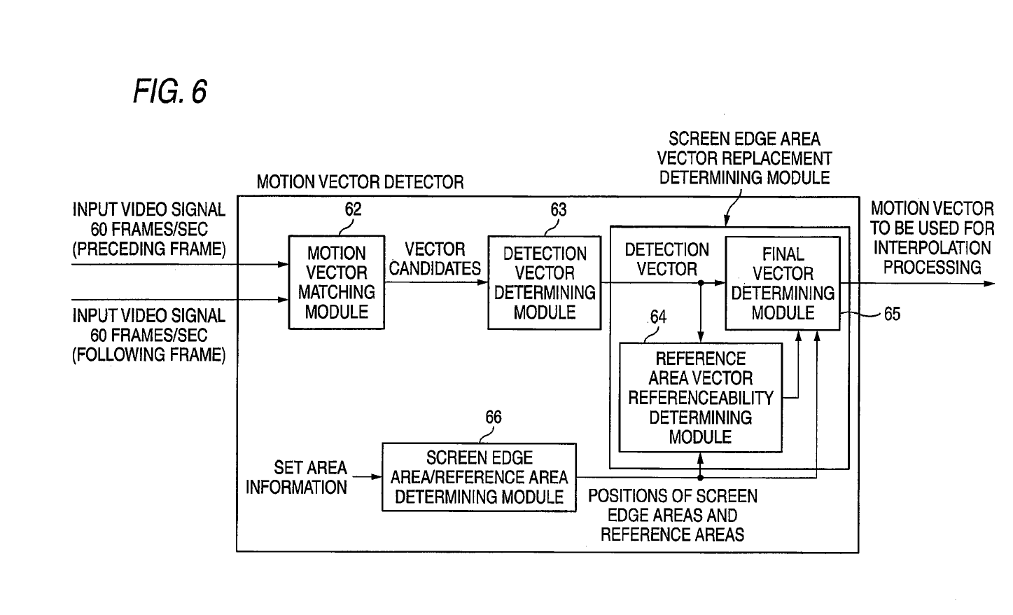

FIG. 6 is a block diagram showing an example configuration of the motion vector detector 3 shown in FIG. 2. The motion vector detector 3 includes a motion vector matching module 62, a detection vector determining module 63, a reference area vector reference-ability determining module 64, a final vector determining module 65, and a screen edge area/reference area determining module 66. The motion vector detector 3 calculates the motion vector of each block and determines the final motion vector. The motion vector matching module 62 detects plural motion vector candidates for each block of an input signal. The detection vector determining module 63 determines, as a detection vector, one motion vector corresponding to a combination of most similar image blocks in a preceding frame and a following frame among the detected motion vector candidates. If image blocks 43 and 44 are most similar image blocks, the vector from the image block 43 to the image block 44 is employed as a motion vector, having a minimum SAD value, of the interpolation block 41. The interpolation block 41 in the interpolation frame 121 is generated based on the thus-determined motion vector and the image data of the image blocks 43 and 44. The above-mentioned local minimum point PS0 is determined when the SAD is determined sufficiently small. The screen edge area/reference area determining module 66 calculates screen edge areas and motion vector reference areas based on the block size and the search range. The reference area vector reference-ability determining module 64 determines whether or not a motion vector of a reference area can be referred to base on a referenceable vector range. The final vector determining module 65 replaces a motion vector of a screen edge area with the motion vector of the reference area depending on the referenceability of the latter.

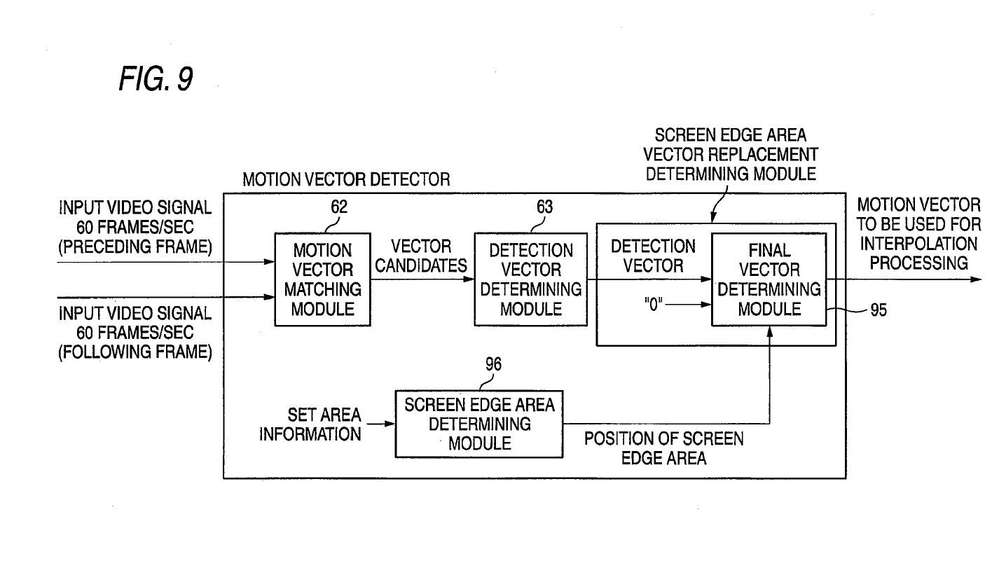

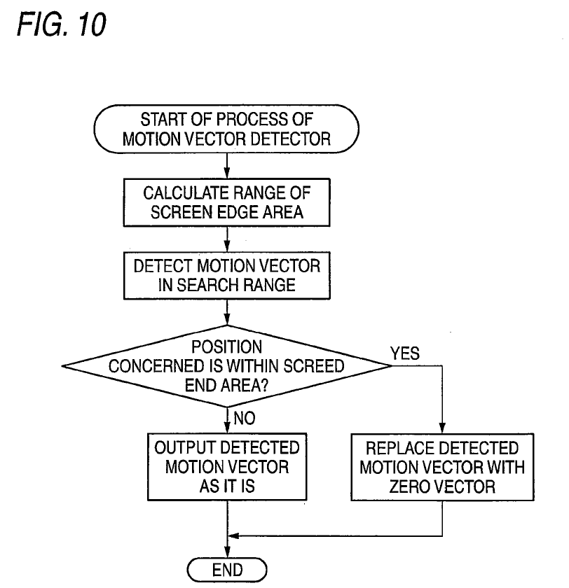

FIG. 9 is a block diagram showing an example configuration of a conventional motion vector detector. Blocks having equivalent blocks in FIG. 6 are given the same reference numerals as the latter. The motion vector detector is composed of a motion vector matching module 62, a detection vector determining module 63, a final vector determining module 95, and a screen edge area determining module 96. FIG. 10 is a flowchart of a process which is executed by the conventional motion vector detector of FIG. 9. Motion vector matching is performed on an input signal, and the vertical component and the horizontal component of a motion vector are switched independently so that only the vertical component of the motion vector is made zero in areas close to the top and bottom ends of the screen and only the horizontal component of the motion vector is made zero in areas close to the left and right ends of the screen.

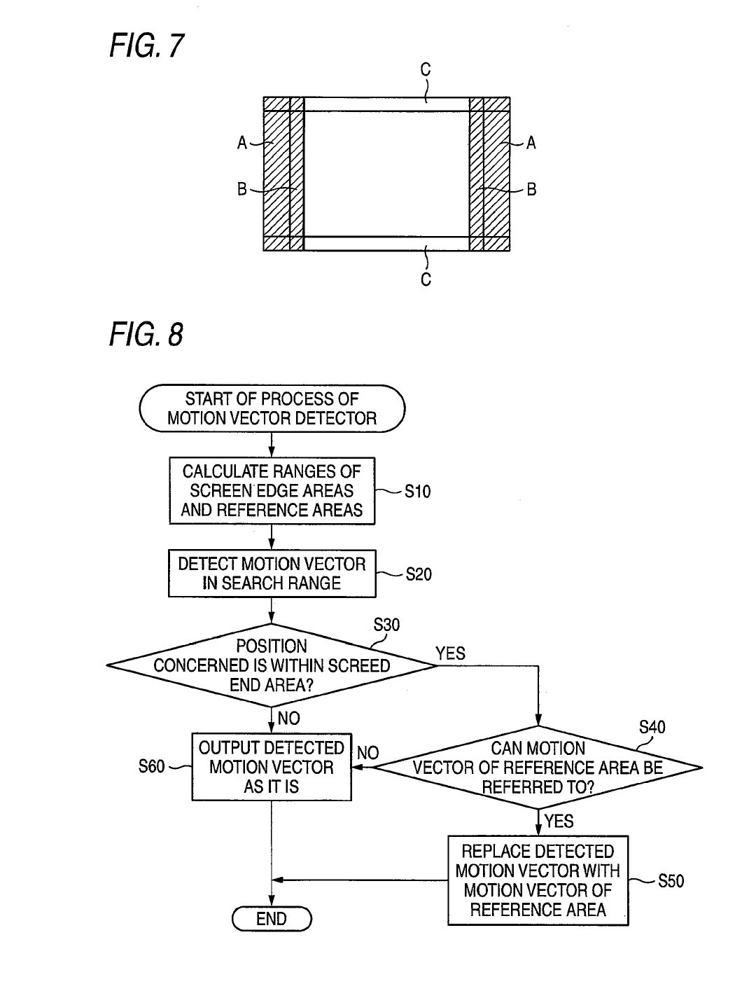

FIG. 7 schematically shows left and right screen edge areas and reference areas on the screen. The following operation is performed when the pixel of attention is located in a left or right end. The screen edge area/reference area determining module 66 determine end areas of an effective image (in this example, end areas of the display screen) based on set area information that has been set by an external section such as the controller 6 based on MB and MSR sizes and is input from it or sync signals included in an input image signal. For example, as shown in FIG. 7, areas which are adjacent to the left end and right end of the display screen, respectively, and have a prescribed width are employed as screen edge areas. Usually, to suppress the circuit scale, the length of a motion vector is restricted so that the terminal point of the motion vector is located in the vector search range. Therefore, it is appropriate to set the width of the screen edge areas a smaller than or equal to the upper limit of the length of a motion vector that can be detected by the motion vector detector 3. In FIG. 7, each screen edge area A is such that the search range MSB of a macroblock MS concerned includes pixels that are located outside the screen. On the other hand, reference areas are such that the search range MSB of a macroblock MS concerned do not includes pixels that are located outside the screen, and areas B which are located inside the respective screen edge areas are set as reference areas. A motion vector of a left or right screen edge area is replaced by a motion vector of a reference area having the same horizontal position as the left or right screen edge area if it can be referred to (example top and bottom end areas are denoted by character C in FIG. 7).

FIG. 8 is a flowchart of a process which is executed by the motion vector detector 3 of the embodiment shown in FIG. 2. Screen edge areas and reference areas are determined by the above detection method. A motion vector is detected by block matching or the like. If the interpolation position of the motion vector is included in a screen edge area, the motion vector of this position is replaced by a referenceable motion vector of the reference area. If a motion vector of the reference area cannot be referred to for a certain reason such as that a determination that the SAD of a local minimum point PS0 is sufficient small has not been made or if the position concerned in out of the screen edge positions, a motion vector of the reference area is not used and a detected motion vector is output as it is. The process will be described below in more detail.

First, at step S10, ranges of screen edge areas and reference area are calculated.

At step S20, a motion vector is detected in a search range.

At step S30, it is determined whether or not the position concerned of the motion vector detected at step S20 is within a screen edge area. If the position concerned not within a screen edge area, the process moves to step S60.

If it is determined at step S30 that the position concerned of the motion vector is within a screen edge area, it is determined at step S40 whether or not a motion vector of the reference area that is located inside the screen edge area can be referred to. If a motion vector of the reference area cannot be referred to, the process moves to step S60.

If it is determined at step S40 that a motion vector of the reference area is effective, at step S50 the detected motion vector is replaced by the motion vector of the reference area. Then, the process is finished.

If it is determined at step S30 that the position concerned not within a screen edge area or if it is determined at step S40 that a motion vector of the reference area cannot be referred to, at step S60 the motion vector detected within the search range is output as it is. Then, the process is finished.

A preferable modification to the above process is as follows. If a motion vector of the reference area that is located inside a screen edge area is effective, the motion vector of the reference area is employed without determining a motion vector in the screen edge area.

In the conventional technique, the vertical component and the horizontal component of a motion vector are switched independently so that only the vertical component of the motion vector is made zero in areas close to the top and bottom ends of the screen and only the horizontal component of the motion vector is made zero in areas close to the left and right ends of the screen. However, there remains a problem that a detected motion vector deviates from a correct one when horizontal or vertical high-speed text scrolling or the like is performed.

In the embodiment, for each of prescribed areas including the top, bottom, left, and right ends, respectively, of an effective image to be displayed on the display panel, referenceability of a vertical or horizontal motion vector of the reference area. And a motion vector of an end area is replaced by a motion vector of the reference area. This lowers the probability of erroneous detection of a motion vector in end areas and makes it possible to reduce disorder or distortion of an interpolated image occurring in areas close to the ends of an effective image. During horizontal or vertical high-speed text scrolling, motion vectors which approximately coincide with an actual movement can be output to enhance the interpolation effect in screen edge areas.

As such, the embodiment provides the following advantages. Since the probability of erroneous detection of a motion vector is lowered or error components can be reduced, the interpolation effect is enhanced in end areas of each interpolated image. In particular, when the horizontal or vertical component of each motion vector is large, interpolated images are given a profound interpolation effect because correct motion vectors can be output for top, bottom, left, and right end areas of the screen.

Although the embodiment according to the present invention has been described above, the present invention is not limited to the above-mentioned embodiments but can be variously modified. Constituent components disclosed in the aforementioned embodiment may be combined suitably to form various modifications. For example, some of all constituent components disclosed in the embodiment may be removed, replaced, or may be appropriately combined with other components.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A frame interpolating device comprising:
a motion vector matching module configured to perform block matching processing to output a plurality of block matching result for respective blocks in an interpolation frame generated by frame interpolating processing using a past frame and a current frame of an input video signal;
a detection vector determining module configured to detect a combination of most similar image blocks in the past frame and the current frame from the block matching results and to employ a motion vector of the detected combination having most similar image blocks as a detection vector;
a reference-ability determining module configured to determine referenceability of the detection vector of a reference area being located inside a screen edge area;
a final vector determining module configured to employ the detection vector determined to be referenceable of the reference area as a motion vector of the screen edge area; and
a frame interpolating module configured to perform frame interpolation processing using the employed detection vector of the reference area.

2. The device of claim 1,
wherein the final vector determining module is configured to replace an original motion vector of the screen edge area with the detection vector of the reference area based on the referenceability of the detection vector of the reference area.

3. The device of claim 1 further comprising:
a display device configured to display an interpolated image being subjected to the frame interpolation processing performed by the frame interpolating module.

4. The device of claim 1 further comprising:
a screen area determining module configured to determine the screen edge area and the reference area.

5. The device of claim 1,
wherein the reference area vector referenceability determining module is configured to determine referenceability of a motion vector of the reference area.

6. A frame interpolating method comprising:
detecting motion vectors using a past frame and a current frame of an input video signal;
determining a screen edge area and a reference area in a frame;
determining motion vector referenceability of a motion vector of the reference area; and
replacing a motion vector of the screen edge area with a motion vector, determined referenceable, of the reference area.
